(19) United States
(12) Patent Application Publication
(10) Pub. No.: US 2018/0031918 A1
(43) Pub. Date: Feb. 1, 2018

(54) BACKLIGHT UNIT AND LIQUID CRYSTAL DISPLAY DEVICE COMPRISING THE SAME

(71) Applicant: Japan Display Inc., Tokyo (JP)

(72) Inventors: Ken SUGIYAMA, Tokyo (JP); Koji HIRAMOTO, Tokyo (JP)

(21) Appl. No.: 15/662,878

(22) Filed: Jul. 28, 2017

(30) Foreign Application Priority Data
Jul. 29, 2016 (JP) 2016-149608
Jun. 1, 2017 (JP) 2017-109484

(51) Int. Cl. G02F 1/1335; F21V 8/00

(52) U.S. Cl. CPC G02F 1/133602; G02B 6/0053; G02B 6/0088; G02B 6/0055; G02B 6/0051

(57) ABSTRACT

According to one embodiment, a backlight device includes a light guide including a first main surface which forms a light-emitting surface, a second main surface and an incidence surface crossing the first and second main surfaces, a light source unit, and an optical sheet on the first main surface of the light guide. The optical sheet includes a light source-side end portion extending over the incidence surface of the light guide to a position opposing the light source unit.

### CROSS-REFERENCE TO RELATED APPLICATIONS

This application is based upon and claims the benefit of priority from Japanese Patent Applications No. 2016-149608, filed Jul. 29, 2016; and No. 2017-109484, filed Jun. 1, 2017, the entire contents of all of which are incorporated herein by reference.

### FIELD

Embodiments described herein relate generally to a backlight unit and a liquid crystal display device comprising the same.

### BACKGROUND

In recent years, liquid crystal display devices are widely used as a display device of smartphones, personal assistant devices (personal digital assistants) (PADs), tablet computers, vehicle-navigation systems, etc. In general, a liquid crystal display device comprises a liquid crystal display panel and a backlight unit overlaid on the rear surface of the liquid crystal display panel and illuminates the liquid crystal panel. The backlight unit includes a reflective layer, a light guide, an optical sheet, a light source unit which irradiates light which enters the light guide, a case (bezel) in which these members are accommodated, etc. The light source unit includes a wiring board and a plurality of light sources, for example, light-emitting diodes (LEDs) mounted on the wiring board.

As light source units, a side-view type LED and top-view type LED are known. In the side-view type LED, the light-emitting surface is provided normal to a mounting surface of the wiring board, whereas in the top-view type LED, the light-emitting surface is provided to face a mounting surface of the wiring board to be parallel thereto.

When using a side-view type LED as the light source unit, the LED is arranged such that the light-emitting surface thereof faces with the incidence surface of the light guide and the wiring board is parallel to the emission surface of the light guide, that is, parallel to the display surface of the liquid crystal panel. Because of this structure, if the wiring board is widened to enable routing of a great number of wiring lines on the wiring board, the wiring board may easily interfere with the display area, thus making it difficult to narrow the frame of the liquid crystal panel.

On the other hand, when using the top-view type LED as the light source unit, the LED is arranged in such a state that the light-emitting surface thereof faces with the incidence surface of the light guide and the wiring board is parallel to the incidence surface of the light guide, that is, to extend in the thickness direction of the backlight unit. With this structure, the wiring board do not interfere with the display area of the liquid crystal panel, and therefore it is advantageous for reducing the size of the backlight device and the width of the frame of the liquid crystal panel.

However, LEDs have, in some cases, a drawback due to their structure, that light passes through and leak from side surfaces other than the light-emitting surface. If light passes through and leaks from the LED, the brightness near the light source unit becomes uneven, undesirably causing an adverse effect on the display quality. When adopting a top-view type LED, the wiring board cannot be utilized for the alignment and fixation of the LED with respect to the light guide, which may undesirably cause an alignment error between the LED and the light guide.

### SUMMARY

The present disclosure generally relates to a backlight unit or device and a liquid crystal display device.

In an embodiment, a backlight device is provided. The backlight device includes a light guide comprising a first main surface forming a light emission surface, a second main surface opposing the first main surface and an incidence surface crossing the first and second main surfaces; a light source unit comprising a wiring board and a light-emitting device on the wiring board, the light-emitting device comprising a light-emitting surface opposing the incidence surface of the light guide and a mounting surface located on an opposite side to the light-emitting surface and mounted on the wiring board, the wiring board opposing the incidence surface while interposing the light-emitting device therebetween; and an optical sheet on the first main surface of the light guide, comprising a light source-side end portion extending over the incidence surface to a position opposing the light-emitting device.

In another embodiment, a liquid crystal display device is provided. The liquid crystal display device includes a liquid crystal panel comprising a first substrate, a second substrate opposed to the first substrate and a liquid crystal layer between the first substrate and the second substrate; and a backlight device opposed to the first substrate; the backlight device including a light guide comprising a first main surface forming a light-emitting surface, a second main surface opposing the first main surface and an incidence surface crossing the first and second main surfaces; a light source unit comprising a wiring board and a light-emitting device on the wiring board, the light-emitting device comprising a light-emitting surface opposing the incidence surface of the light guide and a mounting surface located on an opposite side to the light-emitting surface and mounted on the wiring board, the wiring board opposing the incidence surface while interposing the light-emitting device therebetween; and an optical sheet on the first main surface of the light guide and comprising a light source-side end portion extending over the incidence surface to a position opposing the light-emitting device.

Additional features and advantages are described herein, and will be apparent from the following Detailed Description and the figures.

### BRIEF DESCRIPTION OF THE DRAWINGS

FIG. 1 is a perspective view showing a liquid crystal display device of the first embodiment from a display surface side.

FIG. 2 is a perspective view showing the liquid crystal display device from a rear surface side.

FIG. 3 is a perspective view showing the back surface side of the liquid crystal display device in the state where a main FPC is folded back and fixed.

FIG. 4 is an exploded perspective view of the liquid crystal display device.

FIG. 5 is an exploded perspective view of a backlight unit of the liquid crystal display device.

FIG. 6A is a perspective view showing a light source unit of the backlight unit.

FIG. 6B is a perspective view showing a light source unit of the backlight unit according to a modification.

FIG. 7 is a perspective view showing a light source side of the liquid crystal display device exploded along line A-A of FIG. 3.

FIG. 8 is a perspective view showing the liquid crystal display device, including the cross section corresponding to FIG. 7.

### DETAILED DESCRIPTION

Various embodiments will be described hereinafter with reference to the accompanying drawings. In general, according to one embodiment, a backlight device comprises a light guide comprising a first main surface forming an emission surface, a second main surface opposing the first main surface and an incidence surface crossing the first main surface and the second main surface; a light source unit comprising a wiring board and a light-emitting device on the wiring board, the light-emitting device comprising a light-emitting surface opposing the incidence surface of the light guide and a mounting surface on an opposite side to the light-emitting surface and mounted on the wiring board, the wiring board opposing the incidence surface while interposing the light-emitting device therebetween; and an optical sheet on the first main surface of the light guide, comprising a light source-side end portion extending over the incidence surface to a position opposing the light-emitting device.

Note that the disclosure is presented for the sake of exemplification, and any modification and variation conceived within the scope and spirit of the invention by a person having ordinary skill in the art are naturally encompassed in the scope of invention of the present application. Furthermore, a width, thickness, shape, and the like of each element are depicted schematically in the figures as compared to actual embodiments for the sake of simpler explanation, and they do not limit the interpretation of the invention of the present application. Furthermore, in the description and figures of the present application, structural elements having the same or similar functions will be referred to by the same reference numbers and detailed explanations of them that are considered redundant may be omitted.

### Embodiment

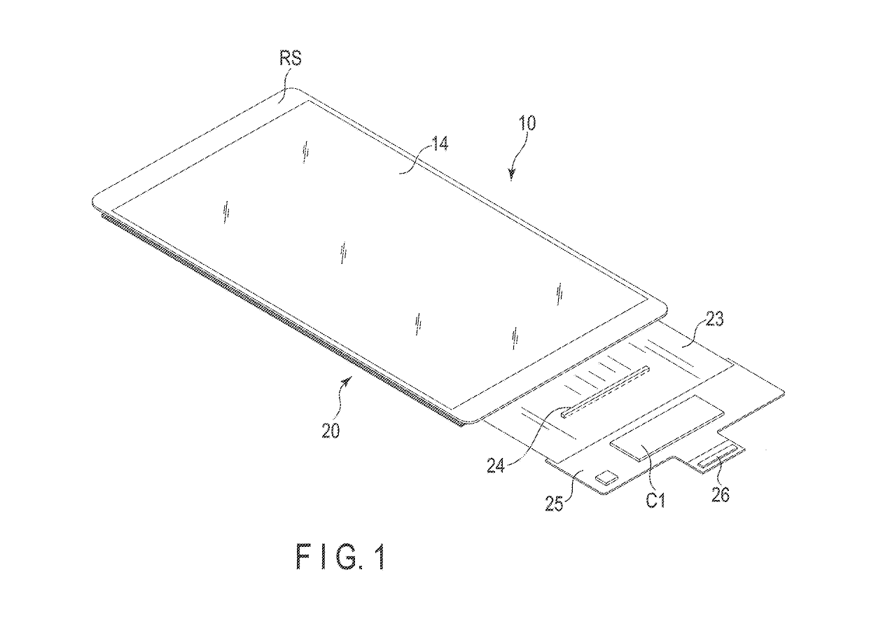

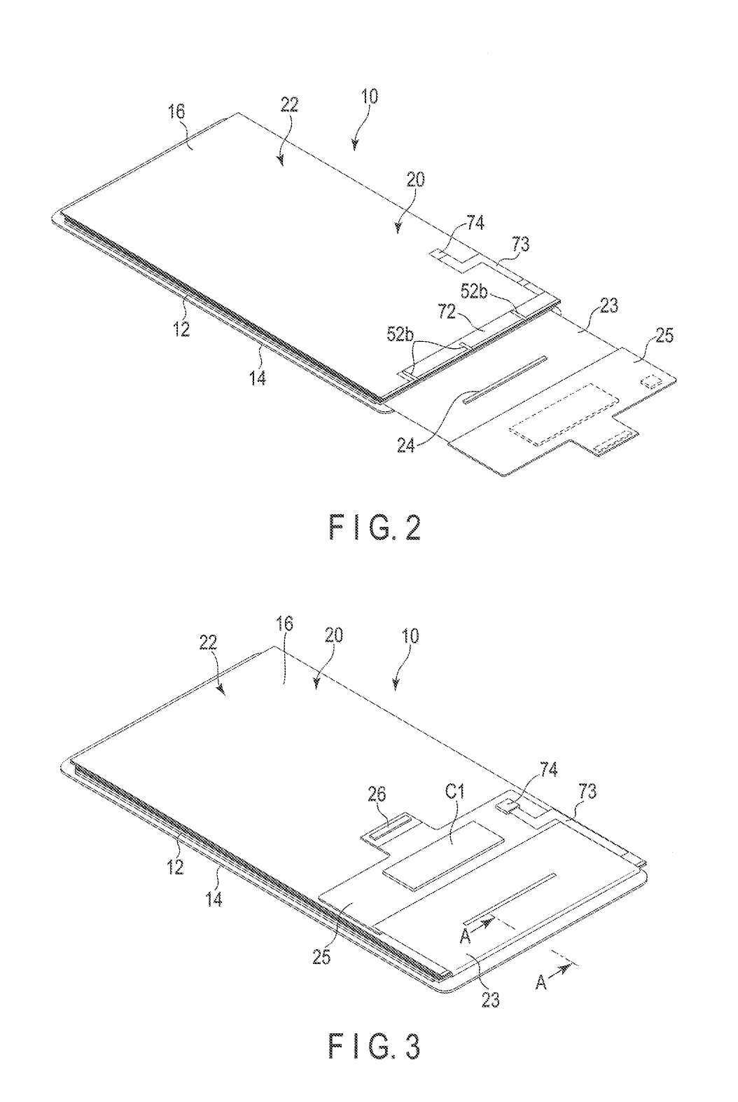

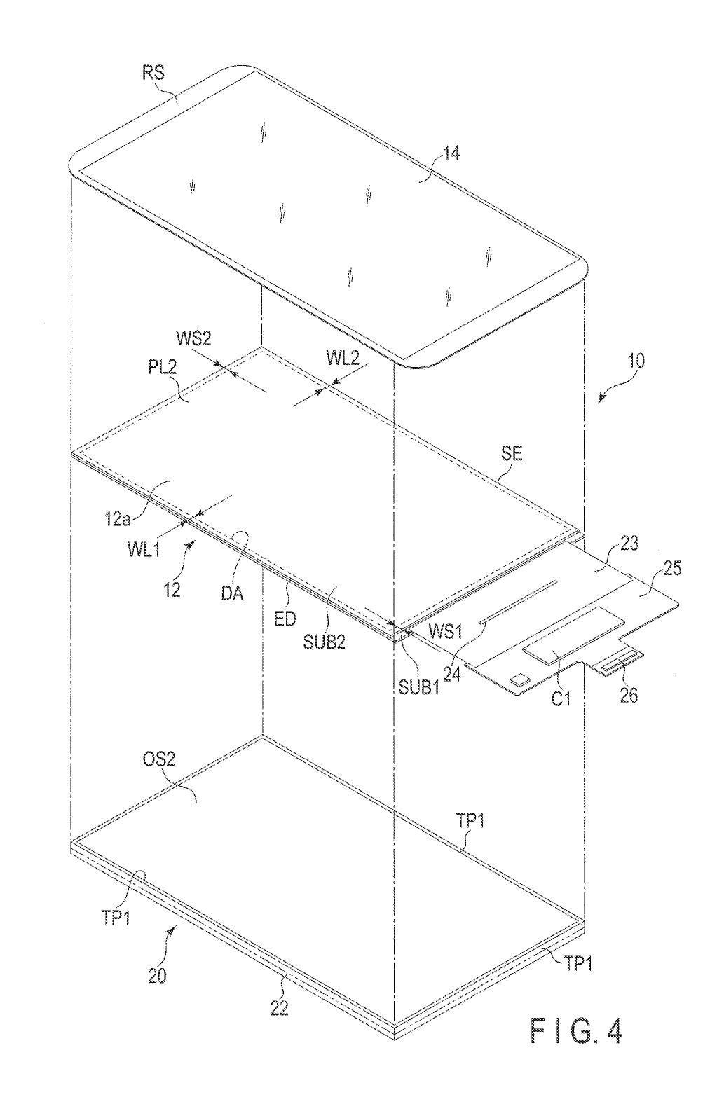

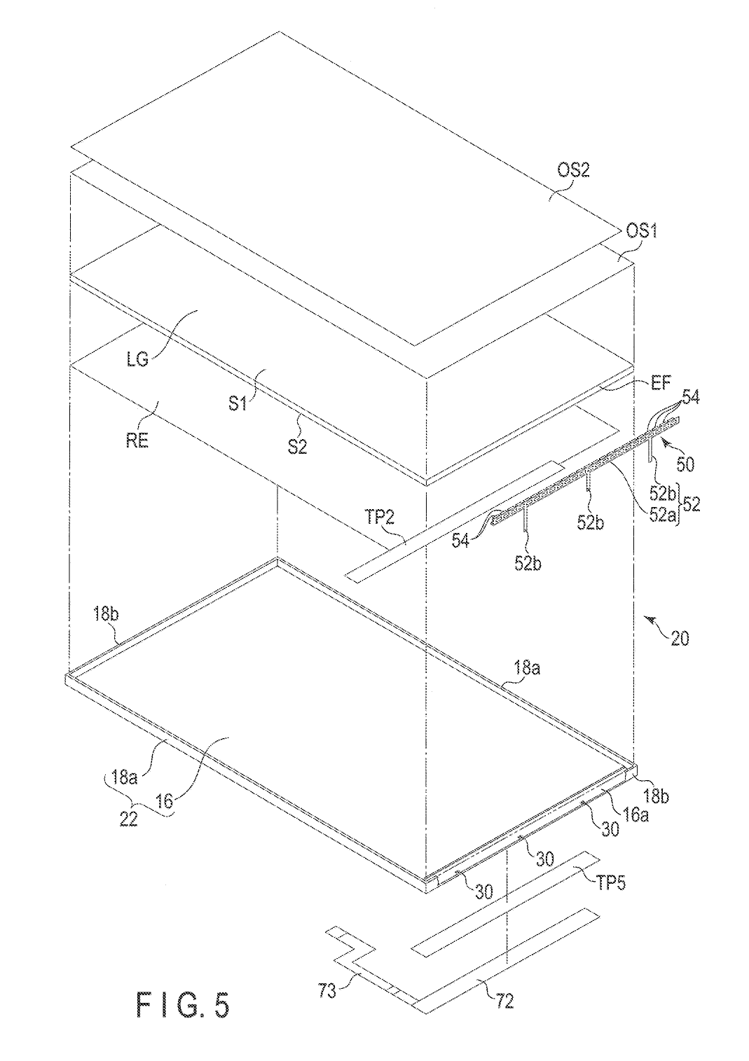

FIGS. 1 and 2 are perspective views showing a liquid crystal display device according to an embodiment as seen from a display surface side and a rear side, respectively. FIG. 3 is a perspective view showing the rear surface side of the liquid crystal display device in the state where a main FPC on which a driver IC is mounted is folded onto the rear surface side. FIG. 4 is an exploded perspective view of the liquid crystal display device.

A liquid crystal display device 10 can be incorporated into, for example, various kinds of electronic devices, such as smartphones, tablet computers, mobile phones, notebook PCs, portable game consoles, electronic dictionaries, television sets and car-navigation systems, to be used.

As shown in FIGS. 1, 2 and 4, the liquid crystal display device 10 comprises an active-matrix liquid crystal panel 12, a transparent cover panel 14 overlaid on a display surface 12a, which is one flat surface of the liquid crystal panel 12 and configured to cover the entire display surface 12a, and a backlight unit 20 as a backlight device, provided to face the rear surface, which is the other flat surface of the liquid crystal panel 12.

The liquid crystal panel 12 comprises a rectangular plate shaped first substrate SUB, a rectangular plate shaped second substrate SUB2 opposed to the first substrate SUB1, and a liquid crystal layer LQ held between the first substrate SUB1 and the second substrate SUB2. A circumferential portion of the second substrate SUB2 is attached to the first substrate SUB1 with a sealing member SE. On the surface of the second substrate SUB2, a polarizer PL2 is attached to form the display surface 12a. A polarizer PL1 is attached on a surface (a rear surface of the liquid crystal panel 12) of the first substrate SUB1.

In the liquid crystal panel 12, a rectangular display area (active area) DA is provided in a region inner side of the sealing member SE as the liquid crystal panel 12 is seen in plan view (, which is a view of the liquid crystal panel from the normal direction of the display surface of the panel), to display images on the display area DA. A rectangular frame area ED is provided around the display area DA. The liquid crystal panel 12 is a transmissive liquid crystal panel having a transmissive display function of displaying imaging by selectively transmitting or modulating the light from the backlight unit 20 to the display area DA. The liquid crystal panel 12 may have a structure provided for the lateral electric field mode which mainly utilizes a lateral electric field substantially parallel to a surface of the substrate, or a structure provided for the vertical electric field mode which mainly utilizes a vertical electric field crossing the main surface of the substrate.

In the example illustrated, a flexible printed circuit board FPC (main FPC) 23 is joined to a shorter side end of the first substrate SUB1 and extends from the liquid crystal panel 12 outward. On the main FPC 23, semiconductor devices including a driver IC 24 are mounted as signal supply sources which supply signals necessary to drive the liquid crystal panel 12. A sub-FPC 25 is joined to the extending edge of the main FPC 23. On the sub-FPC 25, a capacitor C1, a connector 26 and the like are mounted. As shown in FIG. 3, the main FPC 23 and the sub-FPC 25 are folded over along a shorter-side end edge of the first substrate SUB1 and are overlaid on a bottom of the backlight unit 20. As will be described later, the main FPC 23 and the sub-FPC 25 are adhered to the bottom of the backlight unit 20 with an adhesive member such as a double-stick tape.

As shown in FIGS. 1 and 4, the cover panel 14 is formed into a rectangular plate shape from glass or an acrylic transparent resin, for example. The cover panel 14 has dimensions (width and length) greater than those of the liquid crystal panel 12 and an area greater than that of the liquid crystal panel 12 in planar view. The lower surface (rear surface) of the cover panel 14 is adhered to the display surface 12a with an adhesive layer made from a transparent adhesives or adhesive, for example, and covers the entire display surface 12a.

On the lower surface (rear surface, surface on a liquid crystal panel side) of the cover panel 14, a frame-shaped light-shielding layer RS is formed. In the cover panel 14, a region other than the region which opposes the display area DA of the liquid crystal panel 12 is shielded by the light-shielding layer RS. The light-shielding layer RS may be formed on the upper surface (outer surface) of the cover panel 14. Note that the cover panel 14 may be omitted according to the use status of the liquid crystal display device 10.

The backlight unit 20 comprises a case 22, and optical members and a light source unit installed or arranged in the case 22. The backlight unit 20 is disposed to oppose the rear surface of the liquid crystal panel 12 and attached to the rear surface, that is, for example, the polarizer PL1 with a frame-shaped adhesive member, for example, a double-stick tape TP1.

As shown in FIG. 4, in this embodiment, the widths of the edges of the rectangular frame-shaped non-display area ED corresponding to the respective sides of the rectangular display area DA are all the same or substantially the same. More specifically, widths WL1 and WL2 of the non-display area ED, which correspond to a pair of long sides of the display area DA are equal to each other (WL1=WL2). Note here that the widths WL1 and WL2 are referred to as the size from the boundary between the display area DA and the non-display area ED to the outer edge of the first substrate SUB1 (and the second substrate SUB2) in the long sides of the display area. Moreover, of a pair of short sides of the display area DA, the width of the non-display area ED on a side where the flexible printed circuit substrate 23 is provided (, which may be referred to as the mounting side, hereafter) is defined as WS1, and the width of the non-display area ED on a short side edge opposite to thereto is defined as WS2. Here, WS2≦WS1 should be satisfied and WS1/WS2≦2.0 is preferable. More preferably, WS1/WS2≦1.5, and still more preferably, WS1/WS2≦1.0 can be adopted. Here, the width WS1 is defined as the size from the boundary between the display area DA and the non-display area ED to the outer edge of the second substrate SUB2 in the short side on the mounting side of the display area. The width WS2 is defined as the size from the boundary of the display area DA and the non-display area ED to the outer edge of first substrate SUB1 (and second substrate SUB2) in the short side opposite to the mounting side.

Moreover, the above-described structures should preferably satisfy: WL1=WL2<1.5 mm and WS2<1.5 mm, and more preferably, WL1=WL2<1.0 mm and WS2<1.0 mm. Furthermore, in any of these structures, WL1=WL2=WS2 can be adopted.

With the above-described conditions, this embodiment can achieve such a structures that the width WS1 of the mounting side of the liquid crystal panel 12 can be remarkably narrowed then the conventional technique, i.e., the width WS1 of the non-display area on the mounting side can be made substantially equal to that of the other regions of the non-display area ED. Thus, such a liquid crystal panel 12 can be provided with a narrowed frame in which the widths of all the sides of the non-display area ED which surrounds the display area DA are all substantially the same.

Next, the backlight unit 20 will be described in more detail. As described above, in order to achieve a significantly narrowed frame in the non-display area of the mounting side as compared to the conventional techniques, a structure different from that of the conventional techniques is employed especially in the light-source side portion of the backlight unit. The structure of the light-source side portion of the backlight unit will be described in more detail.

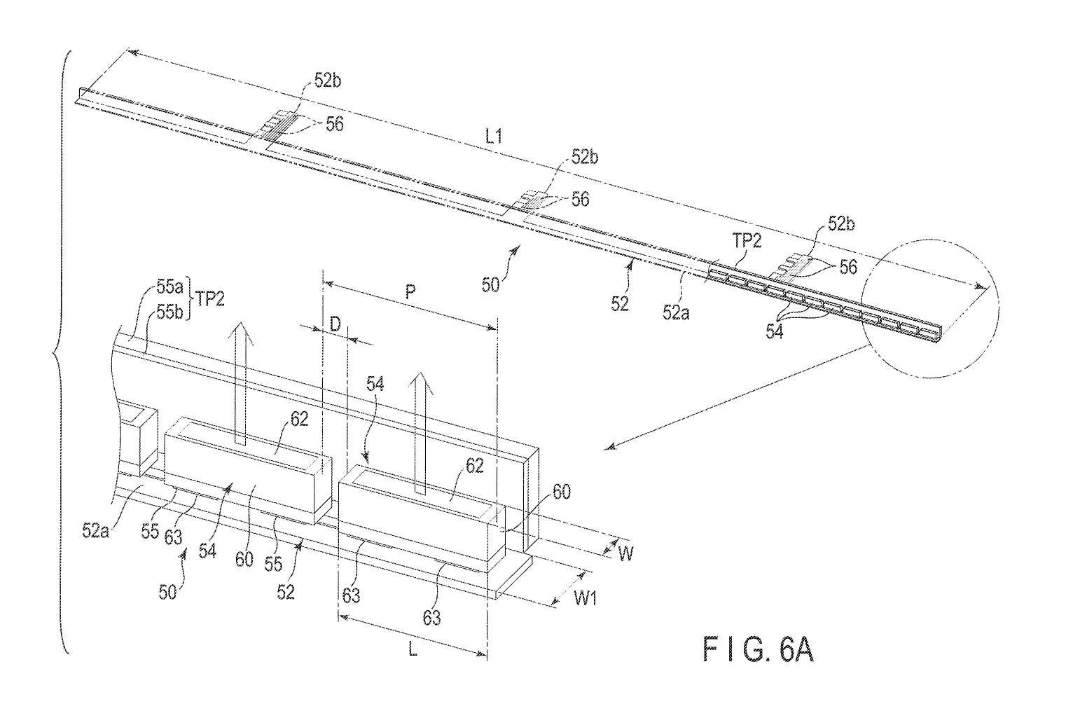

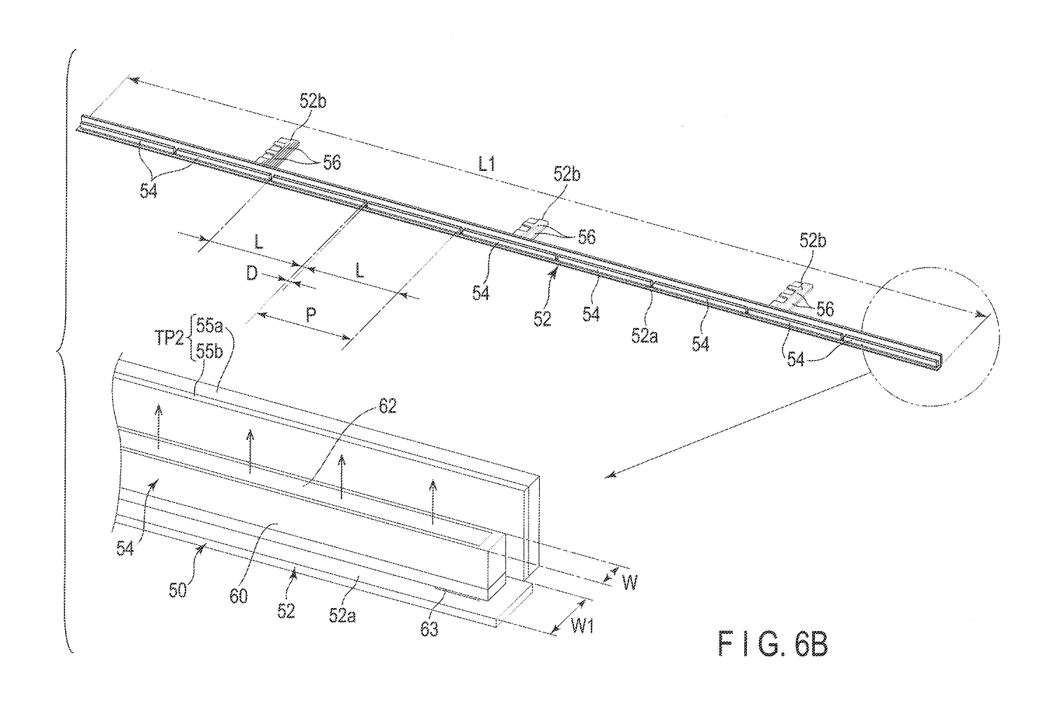

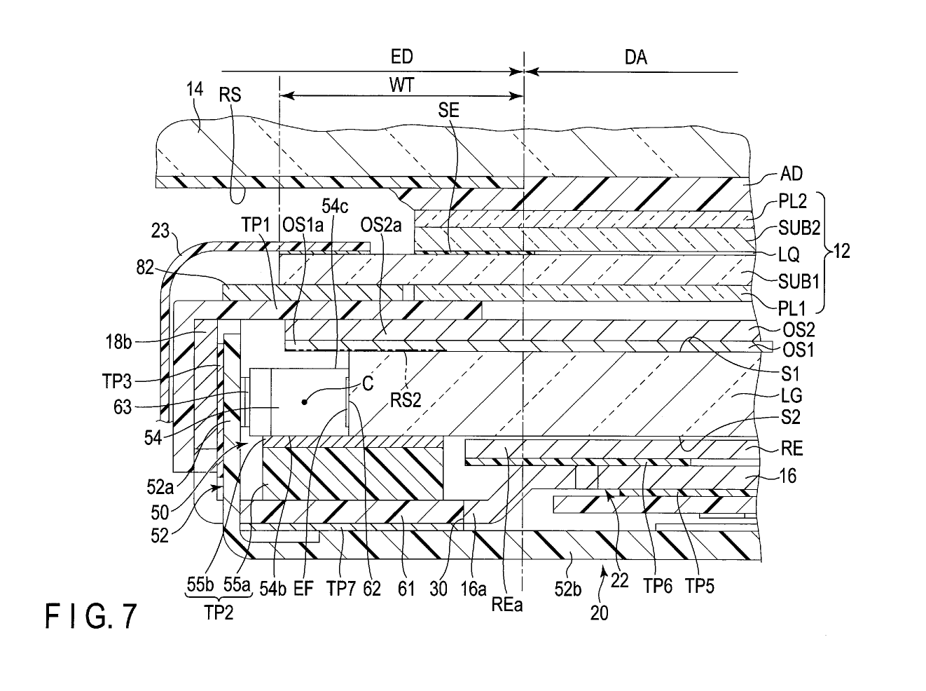

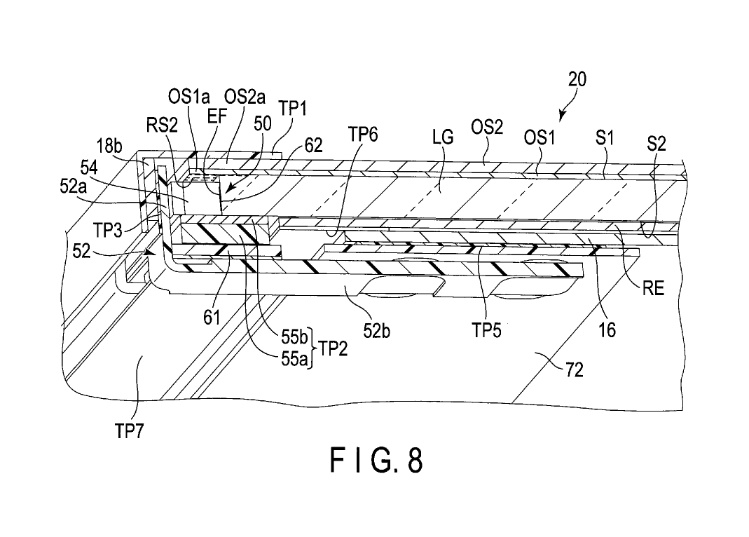

FIG. 5 is an exploded perspective view of the backlight unit 20. FIG. 6A includes perspective views of the light source unit, each including a partially expanded view thereof. FIG. 7 is a cross section of the light-source side portion of the backlight unit taken along line A-A in FIG. 3. FIG. 8 is an exploded perspective view showing the light-source side portion of the backlight unit 20.

As shown in FIG. 5, the backlight unit 20 comprises case (bezel) 22, a plurality of optical members arranged in the case 22, and the light source unit 50 which supplies the light which enters into the optical members.

The case 22 is formed into a flat rectangular lid by, for example, bending or press-molding a stainless plate material having a thickness of 0.1 mm. The case 22 includes a rectangular bottom 16, a pair of long-side walls 18a and a pair of short-side walls 18b, formed to stand on side edges of the bottom 16 and integrated as one body. As shown in FIGS. 5 and 7, in this embodiment, the bottom 16 comprises an end located on a side of one short side and opposing the light source unit 50, which is formed into a step portion (projection) 16a one step lower than the other portion, and to slightly protrude outwards, more specifically, to a direction away from the light-source unit 50 accommodated in the case 22. In planar view, the bottom 16 is formed slightly larger in the dimensions of the first substrate SUB1 of the liquid crystal panel 12, and also smaller than the dimensions (length, width) of those of the cover panel 14.

The long-side walls 18a are formed to stand substantially perpendicular to the bottom 16 and extend over the long sides of the bottom 16 in full length. The short-side walls 18b are formed to stand substantially perpendicular to the bottom 16 and extend over the short sides of the bottom 16 in full length. The height of these side walls 18a and 18b from the bottom 16 is, for example, about 1 mm.

As shown in FIGS. 5 and 7, the bottom 16 has a plurality of; for example, three openings 30. The openings 30 are formed near one short side of the bottom 16 and arranged to be spaced from each other along the short side over substantially full length. In this embodiment, the openings 30 are provided in the step portion 16a of the bottom 16. A width of the openings 30 is greater than a thickness of the wiring board of the light source unit 50, which will be described later.

The backlight unit 20 includes, as optical members, a reflective sheet RE having a rectangular shape in planar view, a light guide LG, a plurality of, for example, two first optical sheets OS1 and second optical sheets OS2. The number of optical sheets is not limited to two, but three or more sheets may be used.

The reflective sheet RE is formed to have outer dimensions substantially equal to the inner dimensions of the bottom 16 of the case 22. The reflective sheet RE has a thickness of 200 μm or less, preferably, 50 to 90 μm and a reflectivity of 90% or higher, preferably, 95% or higher. The reflective sheet RE is provided on the bottom 16 to covers substantially the entire portion of the flat section of the bottom 16 and to oppose only the step portion 16a. With this structure, the openings 30 are not covered by the reflective sheet RE. As shown in FIG. 7, the end REa on the light source side of the reflective sheet RE is extends over the display area DA of the liquid crystal panel 12 to the light source side, and is located on a front side to an incidence surface EF of the light guide LG. A portion of the reflective sheets RE including the end REa is attached to the bottom 16 by double-stick tape TP6.

As shown in FIG. 5 and FIG. 7, the rectangular light guide LG comprises a first main surface S1 functioning as an light-emission surface, a second main surface S2 opposing the first main surface S1 and a plurality of, for example, a pair of long-side side surfaces and a pair of short-side side surfaces, which connect side edges of the first main surface S1 and the second main surface S2 to each other. In this embodiment, one side surface on a short side of the light guide LG is the incidence surface EF. The light guide LG has, for example, a thickness of about 0.23 to 0.32 mm. Moreover, the light guide LG is formed from, for example, a resin such as polycarbonate, an acrylic or silicon resin.

The light guide LG is formed to have outer dimensions (length and width) slightly smaller than the inner dimensions of the case 22 and slightly larger than the display area DA of the liquid crystal panel 12 in planar view. The light guide LG is accommodated in the case 22 and placed on the reflective sheet RE while the second main surface S2 opposes the reflective sheet RE. Thereby, the first main surface (emission surface) S1 of the light guide LG is located substantially parallel to the bottom 16 and the incidence surface EF is located substantially perpendicular to the bottom 16. As shown in FIG. 7, the incidence surface side end of the light guide LG extends over the display area DA to the light source side. Furthermore, the incidence surface side end of the light guide LG extends over the end REa of the reflective sheet RE to the light source side. Thereby, the incidence surface EF is placed to oppose the side wall 18b by the short side of the case 22 with a slight gap therebetween. The gap should preferably be 1.0 mm or less, more preferable 0.8 mm or less, and still more preferably, 0.5 mm or less. Conventionally, the gap is about 3.0 mm to 4.0 mm, and as compared to the conventional structure, the gap between the short side wall 18b and the light guide LG in this embodiment is remarkably narrow. Then, the light source unit 50 is provided in such a gap.

As shown in FIGS. 5 and 6A, the light source unit 50 comprises, for example, a slender belt-shaped wiring board 52 and a plurality of light sources mounted in lines on the wiring board 52. As light sources, light-emitting devices, for example, light-emitting diodes (LEDs) 54 are employed.

A flexible printed circuit board (FPC) is used for the wiring board 52. That is, the wiring board 52 includes an insulating base formed from polyimide or the like and a conductive layer such as a copper foil, formed on the insulating base. The conductive layer is patterned to form a plurality of contact pads 55 and wiring lines 56.

The wiring board 52 includes a belt-shaped mounting portion (mounting region) 52a extending along the side wall 18b of the case 22, and a plurality of for example, three belt-shaped lead-out portions (wiring regions) 52b extending from one side edge of the mounting portion 52a, all integrated as one body. A length L1 of the mounting portion 52a is substantially equal to a length of the incidence surface EF. The three lead-out portions 52b are arranged to be spaced from each other in a longitudinal direction of the mounting portion 52a.

The contact pads 55 are formed in the mounting portion 52a and are arranged in a longitudinal direction of the mounting portion 52a. The wiring lines 56 extend respectively from the contact pads 55 to the lead-out portions 52b and are routed on the lead-out portions 52b.

As shown in FIG. 6A, the LEDs 54 used here are each a top-view type LED. Each LED 54 comprises a substantially rectangular parallelepiped case (package) 60 formed of a resin, for example. An upper surface of the case 60 forms a light-emitting surface 62 and a bottom surface of the case 60, which is located on an opposite side to the light-emitting surface 62, forms a mounting surface. Contact terminals 63 are provided on the bottom of the case 60.

Note that each LED 54 is formed into a substantially rectangular parallelepiped, but the shape is not limited to this. For example, the LED 54 may comprise projections and recesses in side surfaces, or may be formed into a curvy shape.

As to each LED 54, the bottom of the case 60 is mounted on the mounting portion 52a, and thus the contact terminals 63 are electrically connected to the contact pads 55. The light-emitting surface 62 is set substantially parallel to the wiring board 52, and the LED 54 emits light from the light-emitting surface 62 in a direction substantially perpendicular to the wiring board 52.

The LEDs 54 are mounted on the mounting portion 52a so that the longitudinal direction of the case 60 is aligned with the longitudinal direction of the mounting portion 52a. The width W1 of the mounting portion 52a is 1.1 to 1.5 times the width W of the LED 54. In this embodiment, the light source unit 50 includes, for example, thirty to fifty LEDs 54, the number of which may vary according to the width of the display area DA. The number of the LEDs installed is about 2.5 to 3 times that of the conventional structure of the same display area. The LEDs 54 are arranged in one row on the mounting portion 52a from one longitudinal end to the other of the mounting portion 52a.

Note that in this embodiment, an arrangement pitch P of the LEDs 54 is set to about 1.1 to 1.5 times of the length L of each LED 54 in the aligning direction, and a gap D of each adjacent pair of LEDs 54 is set to about 10% to 50% of the length L. Conventionally, the arrangement pitch of LEDs is set to two times or more the length of the LEDs. In this embodiment, the gap D between the LEDs 54 is set narrower than conventional cases, and thus the region of uneven brightness, which may be generated between each adjacent pair of light sources, can be narrowed.

In this embodiment, a belt-shaped fixing tape TP2 as a second adhesive member for fixing and positioning each LED 54 is adhered onto a side surface of each LED 54. The fixing tape TP2 is used such that about a half of the region in a width direction is adhered to each LED 54, and a remaining half of the region is adhered to the light guide LG. The fixing tape TP2 comprises a belt-shaped base material 55a formed of for example, polyethylene terephthalate (PET), and an adhesive layer 55b or sticker layer formed on at least one surface of the base material 55a. Further, at least one of the base material 55a and the adhesive layer 55b is colored in black with, for example, fine black particles, black ink or the like. Thus, the fixing tape TP2 forms a light-shielding member with light shielding property. The fixing tape TP2 employed here is not limited to one continuous tape, but may be of a plurality of divided fixing tapes.

The number of LEDs 54 mounted is not limited to thirty to fifty, but may be increased or decreased as needed. When LEDs longer than the length L1 are used, the number of LEDs to be mounted may be decreased. According to a modification shown in FIG. 6B, the length L1 of the LEDs 54 is set to about 4 to 5 times that of the LEDs 54 shown in FIG. 6A. The width W1 of the mounting portion 52a of the wiring board 52 is 1.1 to 1.5 times the width W1 of the LEDs 54. The arrangement pitch P of the LEDs 54 is set to about 1.1 to 1.5 times the length L1 of the LEDs 54, and the gap D between adjacent pairs of LEDs 54 is about 10% to 50% of the length L1 of the LEDs 54.

As shown in FIGS. 7 and 8, the light source unit 50 configured as described above is arranged in the case 22. The mounting portion 52a of the wiring board 52 and the LEDs 54 are arranged between the incidence surface EF of the light guide LG and the side wall 18b of the case 22. The light-emitting surfaces 62 of the LEDs 54 oppose or abut against the incidence surface EF. The mounting portion 52a is attached to the inner surface of the side wall 18b by an adhesive member, for example, a double-stick tape TP3. The mounting portion 52a opposes the incidence surface EF via the LEDs 54 interposed therebetween. Note that the adhesive material is not limited to the double-stick tape TP3, but, for example, a UV-curing adhesive can be used as well. The light emitted from the LEDs 54 contains light of an ultraviolet region, and therefore it can cure the UV-curing adhesive with this ultraviolet ray.

The fixing tape TP2 is adhered to the side surfaces of all the LEDs 54 (the side surface of the case 22 on the bottom 16 side) and the second main surface S2 of the light guide LG. The LEDs 54 are positioned with respect to the light guide LG and fixed there with the fixing tape TP2.

The LEDs 54 each comprises four side surfaces perpendicularly crossing the light-emitting surface 62. Of the four side surfaces, a long-side surface 54b located on the bottom 16 side is arranged to be substantially flush with the second main surface S2 of the light guide LG. The fixing tape TP2, more specifically, about a half of the region in its width direction, is adhered on the surface side 54b of the LED 54, and the rest of the half is adhered onto an incidence surface-side end portion of the second main surface S2. Each LED 54 has a light emission center C at a location of an equal distance from both of the light-emitting surface 62 and the mounting surface. The fixing tape TP2 covers at least a region of the side surface 54b of the LED 54, which opposes the emission center C. Further, the fixing tape TP2 is arranged along the reflective sheet RE in a surface direction of the light guide LG. That is, the fixing tape TP2 extends to the vicinity of the light source-side end portion REa of the reflective sheet RE, and is arranged in a surface direction of the reflective sheet RE with a slight gap therebetween. Thus, the fixing tape TP2 and the reflective sheet RE are not stacked on each other.

Thus, the LEDs 54 are fixed to the light guide LG via the fixing tape P2, and the light-emitting surface 62 is positioned to abut against the incidence surfaces EF of the light guide LG. Further, the fixing tape TP2 shields the side surface 54b side of each LED 54 to inhibit light from leaking from the LEDs 54.

According to this embodiment, the fixing tape TP2 is formed to be thicker than the reflective sheet RE, and is placed in the step portion 16a of the bottom 16. The fixing tape TP2 is provided to abut against the inner surface of the bottom 16 and cover at least partially each of the openings 30.

Further, as shown in FIG. 7, the end portion of the fixing tape TP2 on the light guide LG opposes the end REa of the reflective sheet RE in the non-display area ED. Furthermore, the end portion of the fixing tape TP2 on the light guide LG opposes end portions of both the polarizing plates PL1 and PL2 via the light guide LG (they are stacked on each other in planar view). In the end portion of the light guide LG, the region thus adhered to the fixing tape TP2 is located to be extremely close to the LEDs 54 as the light source and to oppose the fixing tape TP2 with light-shielding property without opposing the reflective sheet RE. Therefore, at the end portion of the light guide LG, the light from the light source is not reflected on the second main surface S2, and therefore no substantial light is irradiated onto the light emission surface (the first main surface S1) from that region. However, by covering the region by polarizer PL1 and PL2, it is possible to suppress the emitted light from unexpectedly leaking to the display area DA, which may cause the degradation in display quality.

As shown in FIGS. 2 and 5, on the rear surface side of the bottom 16, a belt-shaped connection FPC 72 is fixed by a double-stick tape TP5. The connection FPC 72 extends along a light-source side short edge of the bottom 16. The connection FPC 72 includes a connection portion 73 and a connector 74 is provided at the extending end of the connection portion 73.

As shown in FIGS. 2, 7 and 8, three lead-out portion 52b of the wiring board 52 penetrate the openings 30, respectively, to lead out from the rear side of the bottom 16, and further bent towards a bottom 16 side so as to oppose the rear surface thereof. The lead-out end of each lead-out portion 52b is joined to the connection FPC 72 by solder, for example. Thereby, the wiring lines 56 of the wiring board 52 are electrically connected to the wiring lines of the connection FPC 72. As described above, the width of the openings 30 to which the lead-out portions 52b penetrates is greater than the thickness of the wiring board 52. Therefore, when bending the lead-out portions 52b, they can be bent at a comparatively great curvature without interfering with the bottom 16.

On the rear surface of the bottom 16, a belt-shaped reinforcing double-stick tape TP7 is adhered. The reinforcing double-stick tape TP7 extends along the light source-side short edge of the bottom 16 so as to partially cover each of the openings 30. The lead-out portions 52b led out from the rear surface side via the openings 30 are bent, and the reinforcing double-stick tape T7 is applied thereon. Thus, the lead-out portions 52b are held in the bent state.

Furthermore, in this embodiment, a part of the reinforcing double-stick tape TP7 extends while blocking each of the openings 30, and abuts to the fixing tape TP2 via a spacer 61.

According to this embodiment, as the first optical sheet OS1 and the second optical sheet OS2, a light-transmissive diffusion sheet and a light-transmissive prism sheet, formed from, for example, a synthetic resin such as polyethylene terephthalate, are used. As shown in FIG. 5, the first optical sheet OS1 is formed into a rectangular shape having slightly larger (longer) outer dimensions than those of the light guide LG. The first optical sheet OS1 is overlaid on the first main surface S1 of the light guide LG, to cover the entire first main surface S1. Similarly, the second optical sheet OS2 is formed into a rectangular shape having slightly larger (longer) outer dimensions than those of the light guide LG. The second optical sheet OS2 is overlaid on the first optical sheet OS1, to cover substantially the entire first optical sheet OS1.

As shown in FIGS. 7 and 8, a short-side end portion OS1a of the first optical sheet OS1 extends over the incidence surface EF to a position opposing the LED 54. The end portion OS1a extends to the region opposing the light emission center C of the LED 54.

The first optical sheet OS1 can adopt such a structure that a light-shielding portion RS2 (for example, black printing or a black film) is provided on an edge portion of the first optical sheet OSA, overlapping the light source LED and the incidence surface EF, as indicated by an alternate long and two short dashes line shown in FIG. 7. By adopting such a structure, the light leaking from the light source can be absorbed by the light-shielding portion RS2, and the deterioration in display quality, resulting from the light thus leaking entering the display area DA side can be inhibited more effectively.

The light-shielding portion RS2 should preferably be provided in a predetermined region which covers from the end edge of the first optical sheet (diffusion sheet) OS1 to at least the LED 54 and the incidence surface EF, or more preferably from the incidence surface EF towards the inner side of the light guide LG to such a degree to cover the area approximately equivalent to the thickness of the light guide LG. Moreover, the light-shielding portion RS2 can also adopt such a structure that, for example, a black light-shielding sheet is adhered on either one of the surfaces of the first optical sheet OS1, or the corresponding region of the light-shielding sheet is painted in black.

As described above, in this embodiment, the LEDs 54 are attached and fixed to the light guide LG by the fixing tape TP2. As a result, each of the light-emitting surface 62 of the LEDs 54 abuts to or oppose with a slight gap, the incidence surface EF of the light guide LG, and this state is firmly maintained. Thus, it is possible to inhibit the LEDs 54 from changing their direction with respect to the incidence surface EF in case of an external shock and the like. Moreover, the sites of the double-stick tape TP2 and the light-shielding portion RS2, which oppose the LEDs 54 and the incidence surface EF, are formed in black, and thus a black light-shielding region is provided in each of the spaces above and below the light-emitting surface 62 of each LED 54. In the vicinity of each LED 54 as a light source, the light is emitted radially from the light-emitting surface 62. Of the radially emitted light, incident light entering the incidence surface EF of the light guide LG at a steep angle, for example, 45° or higher, to the normal direction of the incidence surface EF is absorbed by the tape TP2 and the light-shielding portion RS2. On the other hand, incident light entering at a moderate angle, for example, less than 45° to the normal direction travels straight inside the light guide LG or proceeds all the way through to the light guide LG while repeating reflection. As a result, the leakage of light at least towards the up-and-down directions from the light-emitting surface 62 can be restricted remarkably. Here, naturally, the light originally needed is effectively used, and further the light unexpectedly emitted towards the shielding region is absorbed, thereby making it possible to suppress the unexpected light emission towards the display area DA at an angle which is not originally needed.

Note that in the above-provided description, an angle made with respect to the normal direction of the incidence surface EF, which is less than 45° is defined as a moderate angle, whereas an angle which is 45° or more is defined as steep. But the definition of angle may be changed as needed according to the refraction characteristics of the light guide LG, and can be also defined with reference to a larger angle, for example, 50° or 60°, as moderate or steep.

As shown in FIG. 7, a light source-side end portion OS2a of the second optical sheet OS2 projects from the display area DA towards the non-display area ED to overlap the end edge of the first optical sheet OS1, and also extend slightly over the incidence surface EF. The end portion OS2a is located to overlap the end portion OS1a of the first optical sheet OS1 and the light-shielding portion RS2.

As described above, in the non-display area ED as well, the first optical sheet OS1 and the second optical sheet OS2 formed from a prism sheet are stacked on each other and arranged to oppose the end portion of the light guide LG, the incidence surface EF, the light-emitting surface 62 of the LED 54 and the light-shielding portion RS2. With this structure, unexpected leaking light, which is easily generated in a space close to such a kind of a light-emitting site and directed towards the liquid crystal panel 12, is guided to pass the first optical sheet OS1 and the second optical sheet OS2 as so in the display area AD. Therefore, disturbance of the emission light from the backlight device, especially in the edge portion of the display area (end edge of a light-emitting side) can be suppressed.

As shown in FIG. 7, a width WT from the boundary between the display area DA and the non-display area ED to the mounting side end of the first substrate SUB1 should preferably be 1.5 mm or less, and more preferably, 1.3 mm or less.

In this embodiment, each LED 54 of the light source unit 50 is provided in the position overlapping the end edge of the first substrate SUB1 in planar view. As a result, the distance from the boundary between the display area DA and the non-display area ED to the light-emitting surface 62 of the LED 54 is reduced to 1.3 mm or less, or more preferably, 0.8 mm or less, which is remarkably narrower than those of the conventional structures.

According to the conventional structures, the arrangement pitch of the LEDs serving as the point source lights is set about 2 times or more the length of the LEDs, and the gap between the light-emitting surface 62 and the boundary of the display area is about 2.0 mm to 3.0 mm. Thus, according to the conventional structures, the arrangement pitch of the point source lights is widened and the interval from each point source light to the outermost edge of the display area DA is set to be large to some degree, so as to prevent non-uniformity in luminance between adjacent pairs of the point sources lights (LEDs) from appearing in the display area DA. Furthermore, the light entering the incidence surface of the light guide from the light-emitting surface of the LED at an unexpected angle is repeatedly reflected between the light guide and the reflective sheet within the gap, thereby converting the light to be emitted towards the display. Thus, the gap functions as a buffer in a sense.

In this embodiment, the gap as the buffer is remarkably narrow, and it is difficult to solve the problem of the non-uniformity in luminance between the light sources described above with merely such a gap. According to this embodiment, a great number of LEDs 54 are arranged to solve the drawback of the non-uniformity in luminance and further the light-emitting surface and the surrounding of the incidence surface are shielded. Thus, unexpected light from the light-emitting surface 62 is absorbed to achieve stable emission of the light to the display area DA.

The backlight unit 20 configured as above is adhered to the rear surface of the liquid crystal panel 12 by the frame-shaped double-stick tape TP1. As shown in FIGS. 4 and 7, the double-stick tape TP1 is adhered to the end edges of the side walls 18a and 18b and the outer circumferential portion of the second optical sheet OS2. A part of the double-stick tape TP1 is bent to extend toward the bottom 16 and adhered to an outer surface of the side wall 18b on the light source side.

Further, on a liquid crystal panel 12 side, the double-stick tape TP1 is adhered to the circumferential portion of the polarizer PL1 and the circumferential portion of the first substrate SUB1, which interpose a spacer 82 therebetween.

As shown by two dots and dashed lines in FIG. 4, the double-stick tape TP1 may be adhered also to the outer surfaces of the side walls 18a and the other side wall 18b.

As shown in FIGS. 3 and 7, the main FPC23 and the sub FPC25 extending from the liquid crystal panel 12 are folded back to the rear surface side of the bottom 16 along the side wall 18b of the case 22. The main FPC23 and the sub FPC25 are adhered to the bottom 16 with an adhesive member not shown. Moreover, the connector 74 of the connection FPC72 is connected to the connector on the sub FPC25.

In the liquid crystal display device 10 configured as above, the light source unit 50 employs top-view type LEDs 54, and therefore the wiring board 52 of the light source unit 50 can be disposed to oppose the incidence surface EF of the light guide LG while interposing the LEDs 54 therebetween. With this structure, the wiring board 52 does not interfere optical members such as an optical sheet and a light guide and the display area DA of the liquid crystal panel 12, and therefore the light source-side frame area ED can be greatly reduced.

By arranging the light source-side end portion OS1a of the first optical sheet OS1 to oppose the LEDs 54, the light leaking from the case-side surface of each LED 54 to the optical sheet side can be diffused by the first optical sheet OS1. In this embodiment, the light-shielding portion RS2 is provided to shield the light leaking from the case-side surface of each LED 54 to the optical sheet side. Thus, it becomes possible to suppress the light leaking in unnecessary directions and to prevent non-uniformity in luminance and the occurrence of a hot spot. As a result, the display quality of the display device can be improved.

Moreover, the light-shielding portion RS2 is formed by, for example, printing on the optical sheet OS1 and it is remarkably thin as compared to the optical sheet OS1. Therefore, the light source-side end portion of the optical sheet OS1 and the light source-side end portion of the optical sheet OS2 are arranged while they are set along the first main surface S1 of the light guide LG. Thus, the end portion is not warped or bent. As a result, an unexpected light path is not formed in this portion, and therefore it becomes easy to manage the light path from the light source of the LEDs 54. Further, the light-shielding portion RS2 exists in the portion, and therefore, in cooperation with the light-shielding effect by the light-shielding portion RS2, the generation of unexpected leaking light near the light source can be remarkably suppressed.

Moreover, according to this embodiment, the fixing tape (second adhesive member) TP2 is adhered on the side surface of each LED 54 and the second main surface S2 of the light guide LG, and thus the LEDs 54 are positioned and fixed to the light guide LG. With this structure, the LEDs 54 can be held in the state that the light-emitting surfaces thereof abut against the incidence surface EF of the light guide LG, and the optical axis of each LED 54 can be accurately aligned with the incidence surface EF. Further, the fixing tape TP2 has a light-shielding effect, and therefore the light leaking out from the case-side surface of each LED 54 and the light leaking out from the boundary between the light-emitting surface of each LED 54 and the light guide LG can be shielded by the fixing tape TP2. Thereby, the unnecessary leakage of light can be prevented more reliably, making it possible to further improve the display quality of the display device.

According to this embodiment, the wiring board 52 of the light source unit 50 comprises the lead-out portion 52b drawn out to the rear surface side of the bottom 16, and the lead-out portion 52b abuts against the bottom 16. With this structure, the heat generated from the LEDs 54 is transferred to the case 22 of high heat capacity via the wiring board 52, and further the heat is radiated outside from the case 22. Thus, an excessive increase in temperature in the light source portion of the light source unit 50 can be suppressed, and regional increase in temperature in the back light unit 20 can be prevented.

As described above, according to this embodiment, a backlight device which can reduce the width of the frame and improve the display quality, and a liquid crystal display device comprising the backlight device can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

Note that all the structures and production steps which can be carried out by any modification and variation conceived within the scope and spirit of the invention by a person having ordinary skill in the art based on each structural elements described in the embodiments are naturally encompassed in the scope of invention of the present application. Further, regarding the present embodiments, any advantage and effect which would be obvious from the description of the specification or arbitrarily conceived by a skilled person are naturally considered achievable by the present invention.

For example, the light-shielding portion provided in the light source-side end portion of the first optical sheet may be formed from, not only, the black printing or light-shielding film described above, but also some other light-shielding layer. Further, since only the light source-side end portion of the diffusion sheet as the optical sheet can diffuse the leaking light and attenuate it, the light-shielding layer can be omitted.

The outer and inner shapes of the structural members of the display panel and backlight unit are not limited to rectangular, but one or both of the outer and inner shapes may be polygonal, circular, elliptical or combination of any of these in planar view. The materials of the structural members of the display device are not limited to those described in the example provided above, but may be selected from various types.

What is claimed is:

1. A backlight device comprising:
a light guide comprising a first main surface forming a light emission surface, a second main surface opposing the first main surface and an incidence surface crossing the first and second main surfaces;
a light source unit comprising a wiring board and a light-emitting device on the wiring board, the light-emitting device comprising a light-emitting surface opposing the incidence surface of the light guide and a mounting surface located on an opposite side to the light-emitting surface and mounted on the wiring board, the wiring board opposing the incidence surface while interposing the light-emitting device therebetween; and
an optical sheet on the first main surface of the light guide, comprising a light source-side end portion extending over the incidence surface to a position opposing the light-emitting device.

2. The backlight device of claim 1, wherein
the light-emitting device comprises a side surface crossing the light-emitting surface and opposing the light source-side end portion of the optical sheet.

3. The backlight device of claim 2, wherein
the light-emitting device comprises a light emission center located between the light-emitting surface and the mounting surface, and
the light source-side end portion of the optical sheet covers a region opposing the light emission center.

4. The backlight device of claim 1, wherein
the optical sheet includes a diffusion sheet.

5. The backlight device of claim 1, wherein
the optical sheet includes a diffusion sheet on the first main surface of the light guide and a prism sheet on the diffusion sheet.

6. The backlight device of claim 5, wherein
the diffusion sheet comprises the light source-side end portion, and the prism sheet comprises an end portion extending to a position covering a boundary between the incidence surface of the light guide and the light-emitting surface of the light-emitting device.

7. The backlight device of claim 5, further comprising: a light-shielding layer formed in the light source-side end portion of the optical sheet, so as to oppose the light-emitting device.

8. The backlight device of claim 1, further comprising: a light-shielding layer which formed in the light source-side end portion of the optical sheet, so as to oppose the light emitting device.

9. The backlight device of claim 1, wherein
the light-emitting device comprises a side surface crossing the light-emitting surface, the side surface is located along the second main surface of the light guide, and
the device further comprises a second adhesive member adhered on from the side surface of the light-emitting device over to the second main surface of the light guide.

10. A liquid crystal display device comprising:
a liquid crystal panel comprising a first substrate, a second substrate opposed to the first substrate and a liquid crystal layer between the first substrate and the second substrate; and
a backlight device opposed to the first substrate;
the backlight device comprising:
a light guide comprising a first main surface forming a light-emitting surface, a second main surface opposing the first main surface and an incidence surface crossing the first and second main surfaces;
a light source unit comprising a wiring board and a light-emitting device on the wiring board, the light-emitting device comprising a light-emitting surface opposing the incidence surface of the light guide and a mounting surface located on an opposite side to the light-emitting surface and mounted on the wiring board, the wiring board opposing the incidence surface while interposing the light-emitting device therebetween; and
an optical sheet on the first main surface of the light guide and comprising a light source-side end portion extending over the incidence surface to a position opposing the light-emitting device.

11. The liquid crystal display device of claim 10, wherein the optical sheet includes a diffusion sheet.

12. The liquid crystal display device of claim 10, wherein the optical sheet includes a diffusion sheet on the first main surface of the light guide and a prism sheet on the diffusion sheet.

13. The liquid crystal display device of claim 11, wherein the backlight device comprises a light-shielding layer formed in the light source-side end portion of the optical sheet so as to oppose the light-emitting device.

14. The liquid crystal display device of claim 10, wherein the backlight device comprises a light-shielding layer formed in the light source-side end portion of the optical sheet so as to oppose the light-emitting device.
